(19) United States
(12) Patent Application Publication
(10) Pub. No.: US 2022/0138305 A1
(43) Pub. Date: May 5, 2022

(54) AUTHENTICATION OBJECT, AUTHENTICATION SYSTEM, AND AUTHENTICATION MEDIUM PRODUCTION METHOD

(71) Applicant: TOKYO OHKA KOGYO CO., LTD., Kanagawa (JP)

(72) Inventors: Tsuyoshi KUROSAWA, Kanagawa (JP); Ken MIYAGI, Kanagawa (JP); Takahiro DAZAI, Kanagawa (JP)

(21) Appl. No.: 17/427,801

(22) PCT Filed: Jan. 22, 2020
(86) PCT No.: PCT/JP2020/002119

§ 371 Date: Aug. 2, 2021

(30) Foreign Application Priority Data
Feb. 5, 2019 (JP) 2019-018420

(51) Int. Cl. G06F 21/34

(52) U.S. Cl. CPC G06F 21/34; B42D 25/23

(57) ABSTRACT

[Problem] To easily and accurately perform authentication at low cost.

[Means to Solve Problem] Provided is an authentication object C1 that serves as a target of authentication performed by an authentication system, comprising an authentication medium M1 having authentication information that includes a feature related to a pattern of a part of a phase separation structure formed on a substrate from a resin composition for phase separation structure formation and is to be acquired by an acquisition device provided in the authentication system.

### TECHNICAL FIELD

The present invention relates to an authentication object, an authentication system, and an authentication medium production method.

### BACKGROUND ART

In order to distinguish an authentic product serving as an authentication object from non-authentic products such as counterfeit products, it has been proposed to include in an authentication object, an authentication medium to be used for authenticating, and use the authentication medium to authenticate the authentication object (for example, see Patent Literature 1). In Patent Literature 1, a PUF(Physical Unclonable Function) circuit is provided in an authentic product, and authentication is performed by detecting output data from the PUF circuit.

### CITATION LIST

### Patent Literature

[Patent Literature 1] Japanese Unexamined Patent Application, First Publication No. 2015-103048

### SUMMARY OF INVENTION

### Technical Problem

In the authentication technology disclosed in Patent Literature 1, if a physical property of the PUF circuit changes, for example, if a part of the PUF circuit is physically damaged, there is a possibility that output data different from the expected value may be output. In such a case, accurate authentication becomes difficult. Also, creating a PUF circuit for each authentication object is troublesome and causes an increase in cost.

A purpose of the present invention is to provide an authentication object, an authentication system, and an authentication medium production method capable of enabling easy, accurate, and low-cost authentication.

### Means for Solving Problem

A first aspect of the present invention is an authentication object that serves as a target of authentication performed by an authentication system, the authentication object comprising an authentication medium having authentication information that includes a feature related to a pattern of a part of a phase separation structure formed on a substrate from a resin composition for phase separation structure formation and is to be acquired by an acquisition device provided in the authentication system.

A second aspect of the present invention is an authentication system that authenticates the authentication object according to the first aspect of the invention, comprising: an acquisition device that acquires the authentication information from the authentication medium included in the authentication object; and an authentication server that authenticates the authentication information acquired by the acquisition device, on the basis of preliminarily registered authentication data.

A third aspect of the present invention is a method for producing an authentication medium having authentication information, to be authenticated by an authentication system, the method comprising: forming a phase separation structure on a substrate from a resin composition for phase separation structure formation; acquiring an image of a pattern of a part of the phase separation structure; and generating the authentication information, using the image.

### Advantageous Effects of the Invention

According to the aspects of the present invention, it is possible to easily and accurately authenticate an authentication object at low cost, and it is possible to easily distinguish between an authentic product and a non-authentic product.

### BRIEF DESCRIPTION OF THE DRAWINGS

FIG. 1 is a perspective view showing an example of an authentication object according to the present embodiment.

FIG. 2 is a flowchart showing an example of an authentication medium production method.

FIG. 3(A) to FIG. 3(C) are diagrams showing an example of the authentication medium production method.

FIG. 4(D) and FIG. 4(E) are diagrams being a continuation of FIG. 3, showing the example of the authentication medium production method.

FIG. 5(A) and FIG. 5(B) are diagrams showing other examples of the authentication object.

FIG. 6 is a diagram showing another example of the authentication medium.

FIG. 7 is a diagram showing an example of an authentication system according to the present embodiment.

FIG. 8 is a flowchart showing an example of a process in the authentication system.

FIG. 9 is a diagram showing another example of the authentication system according to the present embodiment.

FIG. 10 is a block diagram showing an example of a configuration of an authentication data generation device.

FIG. 11 is a block diagram showing an example of a configuration of an authentication data management server.

FIG. 12 is a diagram showing, in a form of a table, an example of information stored in an authentication data storage.

FIG. 13 is a block diagram showing an example of a configuration of an authentication server.

FIG. 14 is a diagram showing, in a form of a table, an example of information stored in a target information storage.

FIG. 15 is a block diagram showing an example of a configuration of a user terminal.

FIG. 16 is a diagram showing an example of an operation sequence of a scanning electron microscope, the authentication data generation device, and the authentication data management server.

FIG. 17 is a diagram showing an example of an operation sequence of the authentication data management server and the authentication server.

FIG. 18 is a diagram showing an example of an operation sequence of the authentication server and the user terminal.

### DESCRIPTION OF EMBODIMENTS

The following describes an embodiment with reference to the drawings. However, the present invention is not limited to the embodiment. In the drawings, scale is changed as necessary to illustrate the embodiment, such as by enlarging or emphasizing a portion.

### Authentication Object

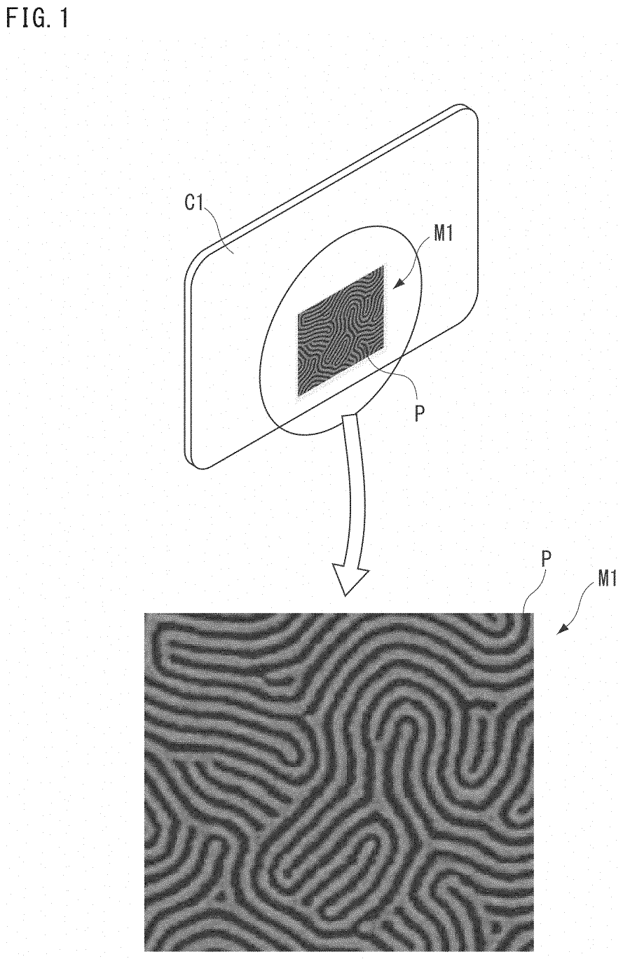

FIG. 1 is a perspective view showing an example of an authentication object according to the present embodiment. The example shown in FIG. 1 will be described, taking a card as an example of an authentication object C1. The authentication object C1 is a target object that serves as a target of authentication performed by an authentication system described later. The authentication object C1 includes an authentication medium M1 having authentication information. The authentication medium M1 is an indicator P that includes an image of a part of a phase separation structure formed on a substrate from a resin composition for phase separation structure formation. The indicator P includes features related to a pattern of a part of the phase separation structure.

The indicator P is used, for example, by printing thereon an image of a part of the phase separation structure. The image used for the indicator P is an image of a part of the phase separation structure formed on a substrate from a resin composition for phase separation structure formation. The image is an image cropped from the phase separation structure on the substrate, for example, in a range from 0.5 μm×0.5 μm to 10 μm×10 μm in height and width. The indicator P is read by an acquisition device 10 included in an authentication system described later. In the present embodiment, the indicator P is an image of 1 μm×1 μm in height and width of the phase separation structure on the substrate.

FIG. 1 shows the indicator P in an enlarged manner. As with human fingerprints, no identical patterns exist in phase separation structures formed on substrates from a resin composition for phase separation structure formation. Therefore, by using a part of the pattern of such a phase separation structure as an authentication medium M1 for authentication, it is possible to perform highly secure authentication as with fingerprint authentication.

In the present embodiment, the indicator P is of a form of having a print of the above image attached to the authentication object C1, however, it may be of a form of having the image being directly printed or marked on a card-shaped authentication object C1. The indicator P may also be a hologram, for example. The dimensions of the indicator P can be adjusted appropriately according to the dimension of the authentication object C1. The card-shaped authentication object C1 may be used, for example, to indicate the ID of a bearer of the authentication object C1. When attaching the indicator P of the authentication object C1, the authentication object C1 itself may serve as an authentication medium. The indicator P may be of a form of being printed on a sticker body and being attachable to the authentication object C1. That is to say, the authentication medium M1 may be a separate body from the authentication object C1. The indicator P (image) serving as an authentication medium M1 is a part of a phase separation structure formed on a substrate from a resin composition for phase separation structure formation. Hereunder, a phase separation structure will be described.

### Resin Composition for Phase Separation Structure Formation

The resin composition for phase separation structure formation mentioned above contains a block copolymer in which a hydrophilic block and a hydrophobic block are bonded, and a solvent component containing an organic solvent.

### Block Copolymer

A block copolymer is a polymer in which a plurality of types of blocks (partial structural components in which structural units of the same type are bonded repeatedly) are bonded. As the blocks constituting the block copolymer, two types of blocks may be used, or three or more types of blocks may be used. The block copolymer in the present embodiment is of a configuration in which a hydrophilic block and a hydrophobic block are bonded.

The hydrophilic block is a block having a relatively higher affinity for water as compared with other blocks among the plurality of blocks constituting the block copolymer. The polymer (p1) constituting the hydrophilic block is composed of structural units having a relatively higher affinity for water as compared with the polymer (p2) constituting the other blocks.

The hydrophobic block is a block other than the hydrophilic block among the plurality of blocks constituting the block copolymer. The polymer (p2) constituting the hydrophilic block is composed of structural units having a relatively lower affinity for water as compared with the polymer (p1).

The plurality of types of blocks constituting the block copolymer are not particularly limited as long as they are of a combination in which phase separation occurs, but a combination of blocks that are immiscible with each other is preferable. The phase composed of at least one type of blocks in the plurality of types of blocks constituting the block copolymer may be a combination that can be easily and selectively removed as compared with the phase composed of other types of blocks.

The phase composed of at least one type of blocks in the plurality of types of blocks constituting the block copolymer may be a combination that can be easily and selectively removed as compared with the phase composed of other types of blocks. Examples of a combination that can be easily and selectively removed include a block copolymer in which one or more types of blocks having etching selectivity greater than 1 are bonded.

Examples of block copolymers include: a block copolymer in which a block of a structural unit having an aromatic group and a block of a structural unit derived from (α-substituted) acrylic acid ester are bonded; a block copolymer in which a block of a structural unit having an aromatic group and a block of a structural unit derived from (α-substituted) acrylic acid are bonded; a block copolymer in which a block of a structural unit having an aromatic group and a block of a structural unit derived from siloxane or a derivative thereof are bonded; a block copolymer in which a block of a structural unit derived from an alkylene oxide and a block of a structural unit derived from (α-substituted) acrylic acid ester are bonded; a block copolymer in which a block of a structural unit derived from an alkyleneoxyde and a block of a structural unit derived from (α-substituted) acrylic acid are bonded; a block copolymer in which a block of a silsesquioxane structure-containing structural unit and a block of a structural unit derived from (α-substituted) acrylic acid ester are bonded; a block copolymer in which a block of a silsesquioxane structure-containing structural unit and a block of a structural unit derived from (α-substituted) acrylic acid ester are bonded; and a block copolymer in which a block of a silsesquioxane structure-containing structural unit and a block of a structural unit derived from siloxane or a derivative thereof are bonded.

Examples of a structural unit containing an aromatic group include a structural unit containing an aromatic group such as a phenyl group and a naphthyl group. Of these, a structural unit derived from styrene or a derivative thereof is preferable.

Examples of styrene or derivatives thereof include α-methylstyrene, 2-methylstyrene, 3-methylstyrene, 4-methylstyrene, 4-t-butylstyrene, 4-n-octylstyrene, 2,4,6-trimethylstyrene, 4-methoxystyrene, 4-t-butoxystyrene, 4-hydroxystyrene, 4-nitrostyrene, 3-nitrostyrene, 4-chlorostyrene, 4-fluorostyrene, 4-acetoxyvinylstyrene, 4-vinylbenzyl chloride, 1-vinylnaphthalene, 4-vinylbiphenyl, 1-vinyl-2-pyrolidone, 9-vinylanthracene, and vinylpyridine.

The (α-substituted) acrylic acid refers to either or both of an acrylic acid, and an acrylic acid in which a hydrogen atom bonded with a carbon atom at the α-position is substituted with another substituent group. Examples of the substituent group include an alkyl group of 1 to 5 carbon atoms. Examples of the (α-substituted) acrylic acid include acrylic acid and methacrylic acid. The (α-substituted) acrylic acid ester refers to either or both of an acrylic acid ester, and an acrylic acid ester in which a hydrogen atom bonded with a carbon atom at the α-position is substituted with another substituent group. Examples of the substituent group include an alkyl group of 1 to 5 carbon atoms.

Examples of the (α-substituted) acrylic acid ester include: acrylic acid ester such as methyl acrylate, ethyl acrylate, propyl acrylate, n-butyl acrylate, t-butyl acrylate, cyclohexyl acrylate, octyl acrylate, nonyl acrylate, hydroxyethyl acrylate, hydroxypropyl acrylate, benzyl acrylate, anthracene acrylate, glycidyl acrylate, 3,4-epoxycyclohexylmethyl acrylate, and trimethoxysilylpropyl acrylate; and methacrylic acid ester such as methyl methacrylate, ethyl methacrylate, propyl methacrylate, n-butyl methacrylate, t-butyl methacrylate, cyclohexyl methacrylate, octyl methacrylate, nonyl methacrylate, hydroxyethyl methacrylate, hydroxypropyl methacrylate, benzyl methacrylate, anthracene methacrylate, glycidyl methacrylate, 3,4-epoxycyclohexylmethyl methacrylate, and trimethoxysilylpropyl methacrylate.

Among these, methyl acrylate, ethyl acrylate, t-butyl acrylate, methyl methacrylate, ethyl methacrylate, and t-butyl methacrylate are preferable. Examples of the siloxane and the derivative thereof include dimethylsiloxane, diethylsiloxane, diphenylsiloxane, and methylphenylsiloxane. Examples of the alkylene oxide include ethylene oxide, propylene oxide, isopropylene oxide, and butylene oxide. As the silsesquioxane structure-containing structural unit, a polyhedral oligomeric silsesquioxane structure-containing structural unit is preferable. As the monomer that provides a polyhedral oligomeric silsesquioxane structure-containing structural unit, a compound having a polyhedral oligomeric silsesquioxane structure and a polymerizable group is preferable.

Among those mentioned above, a block copolymer that contains a block of a structural unit having an aromatic group and a block of a structural unit derived from (α-substituted) acrylic acid or a block of a structural unit derived from (α-substituted) acrylic acid ester is preferable. Of these, mentioned above, a block copolymer that contains a block of a structural unit derived from styrene and a block of a structural unit derived from (α-substituted) acrylic acid or (α-substituted) acrylic acid ester is more preferable. In the block copolymer, the block of a structural unit derived from (α-substituted) acrylic acid or (α-substituted) acrylic acid ester is a hydrophilic block, and the block of a structural unit derived from styrene is a hydrophobic block. In the block copolymer, the polymer (p1) constituting the hydrophilic block is a (α-substituted) acrylic acid polymer or a (α-substituted) acrylic acid ester polymer.

When obtaining a cylindrical phase separation structure oriented perpendicular to the substrate surface, the mass ratio of the structural unit having an aromatic group and the structural unit derived from (α-substituted) acrylic acid or (α-substituted) acrylic acid ester is preferably 60:40 to 90:10, and more preferably 60:40 to 80:20.

Also, when obtaining a lamellar phase separation structure oriented in a direction perpendicular to the substrate surface, the mass ratio of the structural unit having an aromatic group and the structural unit derived from (α-substituted) acrylic acid or (α-substituted) acrylic acid ester is preferably 35:65 to 60:40, and more preferably 40:60 to 60:40.

Specific examples of the block copolymers include: a block copolymer having a block of a structural unit derived from styrene and a block of a structural unit derived from acrylic acid; a block copolymer having a block of a structural unit derived from styrene and a block of a structural unit derived from methyl acrylate; a block copolymer having a block of a structural unit derived from styrene and a block of a structural unit derived from ethyl methacrylate; a block copolymer having a block of a structural unit derived from styrene and a block of a structural unit derived from t-butyl acrylate; a block copolymer having a block of a structural unit derived from styrene and a block of a structural unit derived from methacrylic acid; a block copolymer having a block of a structural unit derived from styrene and a block of a structural unit derived from methyl methacrylate; a block copolymer having a block of a structural unit derived from styrene and a block of a structural unit derived from ethyl methacrylate; a block copolymer having a block of a structural unit derived from styrene and a block of a structural unit derived from t-butyl methacrylate; a block copolymer in which a block of a polyhedral oligomeric silsesquioxane structure (POSS) containing structural unit and a block of a structural unit derived from acrylic acid; and a block copolymer in which a block of a polyhedral oligomeric silsesquioxane structure (POSS) containing structural unit and a block of a structural unit derived from methyl acrylate.

In the block copolymers exemplified above, the polymer (p1) is polyacrylate, poly(methyl acrylate), poly(ethyl acrylate), poly(t-butyl acrylate), polymethacrylate, poly(methyl methacrylate), poly(ethyl methacrylate), poly(t-butyl methacrylate) polyacrylate, or poly(methyl acrylate).

In the present embodiment, it is particularly preferable to use a block copolymer (PS-PMMA block copolymer) having a block of a structural unit derived from styrene (PS) and a block of a structural unit derived from methyl methacrylate (PMMA).

The number average molecular weight (Mn) (by gel permeation chromatography relative to polystyrene standards) of the block copolymer is preferably 2,000 or more, more preferably 8,000 to 200,000, and even more preferably 10,000 to 160,000. The dispersity (Mw/Mn) of the block copolymer is preferably 1.0 to 3.0, more preferably 1.0 to 1.5, and even more preferably 1.0 to 1.3. “Mw” indicates a mass average molecular weight.

In the present embodiment, one type of block copolymer may be used alone, or two or more types may be used in combination. The content of the block copolymer in the resin composition for phase separation structure formation of the present embodiment may be adjusted according to the thickness of the layer containing the block copolymer to be formed.

### Solvent Component

The resin composition for phase separation structure formation of the present embodiment can be prepared by dissolving the above block copolymer in a solvent component. In the present embodiment, the solvent component may be appropriately selected in consideration of the solubility of the block copolymer and the coatability of the resin composition for phase separation structure formation, however, it is preferable that the solvent component contain an organic solvent having a boiling point of 200° C. or higher in terms of phase separation structure pattern formation. The boiling point of the organic solvent is not particularly limited as long as it is 200° C. or higher, however, it is preferably 210° C. or higher, and more preferably 220° C. or higher. The upper limit of the boiling point of the organic solvent is not particularly limited, however, from the viewpoint of annealing treatment temperature and so forth, it is preferably 300° C. or lower, more preferably 280° C. or lower, and even more preferably 250° C. or lower. As the organic solvent, a solvent having a boiling point of 200° C. or higher can be appropriately selected from organic solvents conventionally and commonly known as solvents for film compositions containing a resin as a main component.

Examples of organic solvents include: imidazolidinones such as 1,3-dimethyl-2-imidazolidinone (DMI); lactones such as α-methyl-γ-butyrolactone, and γ-butyrolactone; polyalcohols such as diethylene glycol and dipropylene glycol; compounds having an ester bond such as butyl diglycol diacetate, ethyl diglycol acetate, dipropylene glycol methyl ether acetate, and butylene glycol diacetate; derivatives of polyalcohols such as ethylene glycol, diethylene glycol, propylene glycol, and dipropylene glycol, monoalkyl ethers of compounds having an ester bond such as ethylene glycol monoacetate, diethylene glycol monoacetate, propylene glycol monoacetate, and dipropylene glycol monoacetate, or polyhydric alcohols such as compounds having an ether bond such as monophenyl ether (among these, propylene glycol 1-monophenol ether (PhFG) and dipropylene glycol monobutyl ether (BFDG) are preferable); and aromatic organic solvents such as diphenyl ether, dibenzyl ether, butyl phenyl ether, ethyl benzene, diethyl benzene, and pentyl benzene.

Among the organic solvents mentioned above, derivatives of lactones, imidazolidinones, and polyalcohols are preferable as the organic solvent. Among the lactones, γ-butyrolactone having a substituent is preferable, and α-methyl-γ-butyrolactone can be taken as a preferable example. Among the imidazolidinones, those having an alkyl group as a substituent are preferable, and 1,3-dimethyl-2-imidazolidinone (DMI) can be taken as a preferable example. Among the derivatives of polyalcohols, a derivative having an ether bond of propylene glycol is preferable, and a derivative having a monoalkyl ether or a monophenyl ether of propylene glycol is more preferable. Preferable examples include propylene glycol 1-monophenol ether (PhFG) and dipropylene glycol monobutyl ether (BFDG).

One type of organic solvent may be used alone, or two or more types may be used in combination. The main solvent may be any solvent that can dissolve each component to be used to form a uniform solution, and any one or two or more solvents other than organic solvents can be appropriately selected for use from those conventionally and commonly known as solvents for film compositions containing a resin as a main component.

Examples of the main solvent (Sm) include: lactones such as γ-butyrolactone; ketones such as acetone, methyl ethyl ketone, cyclohexanone, methyl-n-pentyl ketone, methyl isopentyl ketone, and 2-heptanone; polyalcohols such as ethylene glycol, diethylene glycol, and propylene glycol, dipropylene glycol; compounds having an ester bond such as ethylene glycol monoacetate, diethylene glycol monoacetate, propylene glycol monoacetate, and dipropylene glycol monoacetate; derivatives of the polyalcohols mentioned above, monoalkyl ethers such as monomethyl ether, monoethyl ether, monopropyl ether, and monobutyl ether, which are the above compounds having the ester bond mentioned above, or polyalcohols such as compounds having an ether bond such as monophenyl ether (among these, propylene glycol monomethyl ether acetate (PGMEA) and propylene glycol monomethyl ether (PGME) are preferable); cyclic ethers such as dioxane, and esters such as methyl lactate, ethyl lactate (EL), methyl acetate, ethyl acetate, butyl acetate, methyl pyruvate, ethyl pyruvate, methyl methoxypropionate, and ethyl ethoxypropionate; and aromatic organic solvents such as anisole, ethyl benzyl ether, cresylmethyl ether, diphenyl ether, dibenzyl ether, phenetole, butyl phenyl ether, ethyl benzene, diethyl benzene, pentyl benzene, isopropylbenzene, toluene, xylene, cymene, and mesitylene.

One type of these main solvents may be used alone, or two or more types may be used in combination. Among these main solvents, propylene glycol monomethyl ether acetate (PGMEA), propylene glycol monomethyl ether (PGME), cyclohexanone, and ethyl lactate (EL) are preferable.

### Arbitrary Components

In addition to the block copolymers and solvent components mentioned above, the resin composition for phase separation structure formation of the present embodiment may, as required, further contain a miscible additive, such as additional resin to improve the performance of the base layer, a surfactant to improve coatability, a dissolution inhibitor, a plasticizer, a stabilizer, a colorant, an antihalation agent, a dye, a sensitizer, a base growth agent, and/or a basic compound, where appropriate.

### Authentication Medium Production Method

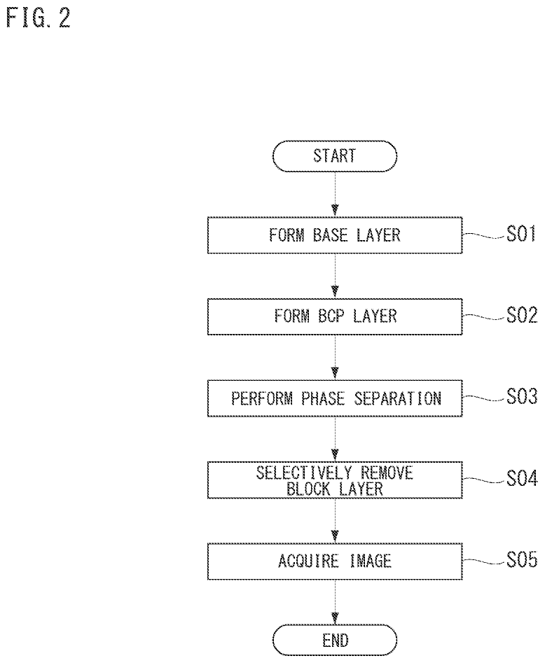

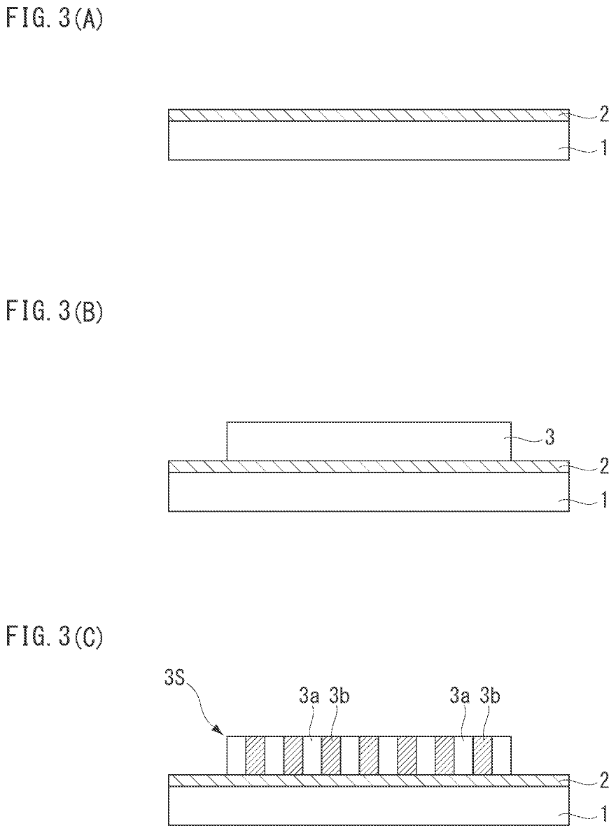

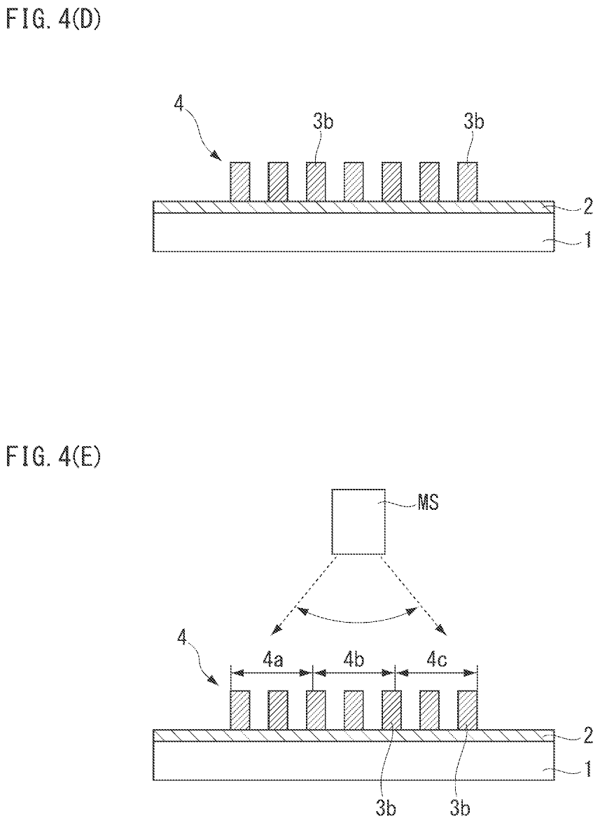

Hereinafter, an authentication medium production method according to the present embodiment is described specifically, with reference to FIG. 2 to FIG. 4. FIG. 2 is a flowchart showing an example of the authentication medium production method. FIG. 3(A) to FIG. 3(C) are diagrams showing an example of the authentication medium production method. FIG. 4(D) and FIG. 4(E) are diagrams being a continuation of FIG. 3, showing the example of the authentication medium production method. The authentication medium production method according to the present embodiment includes a method for manufacturing a structure containing a phase separation structure. The method for manufacturing a structure containing a phase separation structure includes a step of coating a supporting body with the resin composition for phase separation structure formation mentioned above to form a layer containing a block copolymer, and a step of phase-separating the layer containing the block copolymer.

As shown in FIG. 2, first, a substrate 1 is coated with a primer to form a base layer 2 (Step S01, see FIG. 3 (A)). Next, the base layer 2 is coated with the resin composition for phase separation structure formation to form a layer containing a block copolymer (BCP layer) (Step S02, see FIG. 3(B)). Next, the BCP layer 3 is heated and annealed so as to phase-separate it into a phase 3a and a phase 3b (Step S03, see FIG. 3(C)). Next, in the BCP layer 3, the phase consisting of at least one type of block among the plurality of types of blocks constituting the block copolymer is selectively removed (Step S04, see FIG. 4(D)). It should be noted that Step S04 need not always be performed. Next, an image of a pattern of a part of the BCP layer 3 is acquired (Step S05, see FIG. 4(E)). Hereinafter, each step will be specifically described.

### Base Layer Formation

As shown in FIG. 3(A), in Step S01, the base layer 2 is formed on the substrate 1. The type of the substrate 1 is not particularly limited as long as the surface thereof can be coated with a primer (or a resin composition for phase separation structure formation). Specific examples of the substrate 1 includes a substrate composed of a metal such as silicon, copper, chrome, iron, and aluminum, a substrate composed of an inorganic substance such as glass, titanium oxide, silica, and mica, and a substrate composed of an organic compound such as acrylic plate, polystyrene, cellulose, cellulose acetate, and phenol resin.

The size and shape of the substrate 1 are not particularly limited. The substrate 1 need not have a smooth surface, and BOP a supporting body made of various materials and having various shapes can be appropriately selected for use. For example, a multitude of shapes can be used, such as a substrate having a curved surface, a plate having a concavo-convex surface, and a thin sheet. For example, in the case where the image used for the indicator P mentioned above is 1 μm×1 μm in height and width, approximately 70,650 million images can be acquired when a 300 mm silicon wafer is used as the substrate 1.

An inorganic and/or organic film may be provided on the surface of the substrate 1. Examples of inorganic films include an inorganic anti-reflection film (inorganic BARC). Examples of organic films include an organic anti-reflection film (organic BARC).

The surface of the substrate 1 may be cleaned before the base layer 2 is formed on the substrate 1. Cleaning the surface of the substrate 1 allows better coating of the resin composition for phase separation structure formation or the primer on the substrate 1. A commonly known method can be used as the cleaning treatment, and examples thereof include oxygen plasma treatment, hydrogen plasma treatment, ozone oxidation treatment, acid-alkali treatment, and chemical modification treatment. For example, the supporting body is immersed in an acid solution such as a sulfuric acid/hydrogen peroxide aqueous solution, washed with water, and dried. After that, the base layer 2 is formed on the surface of the substrate 1.

The formation of the base layer 2 is a neutralization treatment performed the substrate 1. The neutralization treatment is a treatment of modifying the surface of the substrate 1 so as to have an affinity with any of the polymers constituting the block copolymer. By performing the neutralization treatment, it is possible, due to phase separation, to suppress only the phase composed of a specific polymer from coming into contact with the surface of the substrate 1. The base layer 2 is formed according to the type of block copolymer used. As a result, the phase separation of the BCP layer 3 facilitates the formation of a cylindrical or lamellar phase separation structure oriented in the direction perpendicular to the surface of the substrate 1.

Specifically, the base layer 2 is formed on the surface of the substrate 1, using a primer having an affinity with any polymer constituting the block copolymer. As the primer, a commonly known resin composition used for thin film formation can be appropriately selected and used, depending on the type of polymers constituting the block copolymer. Examples of this primer include a composition containing a resin having each structural unit of the polymers constituting the block copolymer, and a composition containing a resin having each structural unit with affinity for the polymers constituting the block copolymer.

For example, in the case where a block copolymer (PS-PMMA block copolymer) having a block of a structural unit derived from styrene (PS) and a block of a structural unit derived from methyl methacrylate (PMMA), as the primer, it is preferable to use a resin composition containing both PS and PMMA as blocks, or a compound or a composition containing both a site having a high affinity for aromatic rings and a site having a high affinity for highly polar functional groups. Examples of resin compositions containing both PS and PMMA as blocks include a random copolymer of PS and PMMA, and an alternating polymer of PS and PMMA (each monomer is copolymerized alternately).

Examples of compositions containing both a site having a high affinity for PS and a site having a high affinity for PMMA include a resin composition obtained by polymerizing, as monomers, at least a monomer having an aromatic ring and a monomer having a highly polar substituent. Examples of monomers having an aromatic ring include a monomer having a group obtained by removing one hydrogen atom from the ring of aromatic hydrocarbon, such as a phenyl group, a biphenyl group, a fluorenyl group, a naphthyl group, an anthryl group, and a phenanthryl group, and a monomer having a heteroaryl group in which some of the carbon atoms constituting the ring of these groups are replaced with hetero atoms such as oxygen atoms, sulfur atoms, or nitrogen atoms. Examples of monomers having a highly polar substituent include a monomer having a hydroxyalkyl group in which some of hydrogen atoms of a trimethoxysilyl group, a trichlorosilyl group, a carboxy group, a hydroxyl group, a cyano group, and an alkyl group are substituted with fluorine atoms.

Examples of compounds containing both a site having a high affinity for PS and a site having a high affinity for PMMA include a compound containing both an aryl group and a highly polar substituent such as phenetyl trichlorosilane, and a compound containing both an alkyl group and a highly polar substituent such as an alkylsilane compound.

Examples of the primer also include thermopolymerizable resin compositions and photosensitive resin compositions such as positive resist compositions, and negative resist compositions. These base layers can be formed by means of a conventional method. The method of coating the substrate 1 with the primer to form the base layer 2 is not particularly limited, and the base layer 2 can be formed by means of a commonly known method. For example, the base layer 2 can be formed by coating the substrate 1 with the primer by means of a commonly known method such as spin coating or using a spinner, and then drying the coating.

As a method for drying the coating film, it is sufficient to volatilize the solvent contained in the primer, and examples of this method include baking. At this time, the baking temperature is preferably 80 to 300° C., more preferably 180 to 270° C., and even more preferably 220 to 250° C. The baking time is preferably 30 to 500 seconds, and more preferably 60 to 400 seconds. The thickness of the base layer 2 after drying the coating film is preferably approximately 10 to 100 nm, and more preferably about 40 to 90 nm. It should be noted that Step S01 need not always be performed. That is to say, the BCP layer 3 may be formed on the substrate 1 without forming the base layer 2.

### BCP Layer Formation

As shown in FIG. 3(B), in Step S02, the BCP layer 3 is formed on the base layer 2, using the resin composition for phase separation structure formation. The method for forming the BCP layer 3 on the base layer 2 is not particularly limited, and examples thereof include a method in which the base layer 2 is coated with the resin composition for phase separation structure formation to form a coating film by means of a commonly known method such as spin coating or using a spinner, and then drying the coating. As the method for drying the resin composition for phase separation structure formation, it is sufficient to volatilize the organic solvent component contained in the resin composition for phase separation structure formation, and examples of this method include shake-off drying and baking.

The sufficient thickness of the BCP layer 3 is an adequate thickness that allows phase separation to occur, and is preferably 5 to 100 nm, and more preferably 30 to 80 nm, taking into consideration the type of the substrate 1, or the size of structural period or the nanostructure uniformity of the phase separation structure to be formed. For example, in the case where the substrate 1 is a Si substrate or a SiO2 substrate, the thickness of the BCP layer 3 is preferably 20 to 100 nm, and more preferably 30 to 80 nm. For example, in the case where the substrate 1 is a Cu substrate, the thickness of the BCP layer 3 is preferably 10 to 100 nm, and more preferably 30 to 80 nm.

### Phase Separation

As shown in FIG. 3(C), in Step S03, the BCP layer 3 formed on the substrate 1 is phase-separated. A phase separation structure is formed by heating and annealing the substrate 1 that has undergone Step S02. That is to say, a structure 3S phase-separated into a phase 3a and a phase 3b is formed on the substrate 1.

The temperature condition of the annealing treatment is preferably at least the glass transition temperature of the block copolymer used but not more than the thermal decomposition temperature of the block copolymer used. For example, in the case where the block copolymer is a PS-PMMA block copolymer (number average molecular weight 2,000 to 200,000), the temperature condition of the annealing treatment is preferably 100 to 400° C., more preferably 120 to 350° C., and particularly preferably 150 to 300° C. The heating time is preferably 30 to 3,600 seconds, and more preferably 120 to 600 seconds. Further, it is preferable that the annealing treatment be performed in a low-reactivity gas such as nitrogen.

### Selective Removal of Block Layer

In Step S04, as shown in FIG. 4(D), from the BCP layer 3 formed on the base layer 2, the phases composed of at least one type of block (phase 3a, phase 3b) among the plurality of types of blocks constituting the block copolymer are selectively removed. As a result, a phase separation structure is formed so that at least a part of the surface of the substrate 1 is exposed. Examples of the method for selectively removing the phases (phase 3a, phase 3b) composed of one type of block include a method of performing oxygen plasma treatment on the BCP layer 3 and a method of performing hydrogen plasma treatment on the BCP layer 3.

For example, after having phase-separated the BCP layer 3 containing the PS-PMMA block copolymer, the BCP layer 3 is subjected to an oxygen plasma treatment or hydrogen plasma treatment to selectively remove the phases composed of PMMA. In the present embodiment, as shown in FIG. 4(D), the structure 3S manufactured on the substrate 1 is subjected to an oxygen plasma treatment to selectively remove the phase 3a to form a structure 4 having a pattern composed of the separated phases 3b (polymer nanostructure).

While the substrate 1 on which the structure 4 is formed as a result of phase-separating the BCP layer 3 can be used as it is, it is also possible to change the shape of the pattern (polymer nanostructure) on the substrate 1 by further applying heat thereto. The temperature condition of the heat application is preferably at least the glass transition temperature of the block copolymer used but not more than the thermal decomposition temperature of the block copolymer used. Also, it is preferable that the heat application be performed in a low-reactivity gas such as nitrogen. It should be noted that Step S04 need not always be performed. That is to say, if an image of a part of the phase separation structure can be acquired in the following Step S05, the following Step S05 may be performed while the structure 3S is still present (without performing Step S04).

### Image Acquisition

In Step S05, as shown in FIG. 4(E), an image of a pattern of a part of the structure 4 (phase separation structure) is acquired. Acquisition of the image is performed by a scanning electron microscope MS. The scanning electron microscope MS focuses an electron beam and emits the electron beam to the structure 4 (or structure 3S), and detects secondary electrons, reflection electrons, transmission electrons, X-rays, cathodoluminescence, electromotive force, and so forth radiated from the structure 4, to thereby observe the target. In Step S05, the scanning electron microscope MS acquires (captures) an image of each predetermined region of the structure 4.

The size of the image acquired in Step S05 is, for example, in the range from 0.5 μm×0.5 μm to 10 μm×10 μm in height and width. The scanning electron microscope MS may image-capture the structure 4 at a magnification of 300K or less, for example. The scanning electron microscope MS may emit an electron beam to the entire structure 4 to acquire an image of the entire structure 4 and the image may be used as an image of the indicator P, or may emit an electron beam to each of some parts of the structure 4 to appropriately acquire images.

For example, after having image-captured one region 4a of the structure 4 using the scanning electron microscope MS, the range of electron beam emission performed by the scanning electron microscope MS is shifted to image-capture another region 4b. Subsequently, the electron beam emission range is further shifted to image-capture another region 4c. By repeating this operation, images of a plurality of different patterns are acquired for the structure 4 formed on a single substrate 1. These images may be analog images or digital images. The acquired image is provided on an authentication medium M1 such as the indicator P as authentication information that includes features related to a part of the structure 4 (phase separation structure). The authentication medium M1 may be, for example, an indication body on which the indicator P is indicated. The indicator P becomes indicative on the indicator P, for example, by being printed or marked on the indication body. The indicator P may also be a hologram, for example. The dimensions of the indicator P can be adjusted appropriately according to the dimension of the indication body.

As described above, according to the authentication medium production method of the present embodiment, a multitude of images each having a different feature can be obtained from the structure 4 (phase separation structure) formed on a single substrate 1. Therefore, a multitude of authentication media M1 having the features of these images can be produced easily. Since the acquired images have different features, it is possible to accurately authenticate the authentication object C1 by using these features.

### Other Examples of Authentication Object

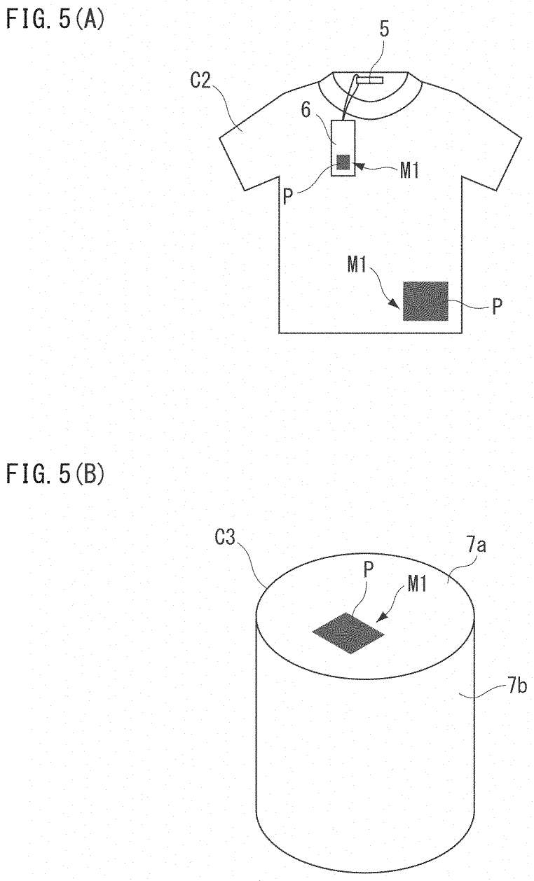

FIG. 5(A) and FIG. 5(B) are diagrams showing other examples of the authentication object. In FIG. 5 (A), for example, the indicator P is provided as an authentication medium M1 on a clothing or the like serving as an authentication object C2. The indicator P may be printed on the authentication object C2 (clothing), or may be a pattern similar to the image provided thereon by means of embroidering or the like. The indicator P may be provided on the outer surface side of the clothing serving as the authentication object C2, or may be provided on the inner surface side. The indicator P may be provided on a tag 5, which is typically provided on a clothing. As shown in FIG. 5(A), the indicator P may be provided as an authentication medium M1 on a store tag 6, which is attached to the authentication object C2 at the time of sale or the like.

In FIG. 5(B), for example, the indicator P is provided as an authentication medium M1 on the surface of a container or the like serving as an authentication object C3. The container or the like serving as an authentication object C3 is of a cylindrical shape, for example, having a flat surface 7a and a curved surface 7b, and the indicator P is formed on the flat surface 7a. However, the invention is not limited to this configuration and the indicator P may be formed on the curved surface 7b. The indicator P may also be provided in a form in which the indicator P having an image printed thereon as an authentication medium M1 is attached to the flat surface 7a, or in a form in which the image is directly printed on the flat surface 7a. As the indicator P, a marking similar to the image may be provided on the flat surface 7a. The container 7 may be of another shape.

### Another Example of Authentication Medium

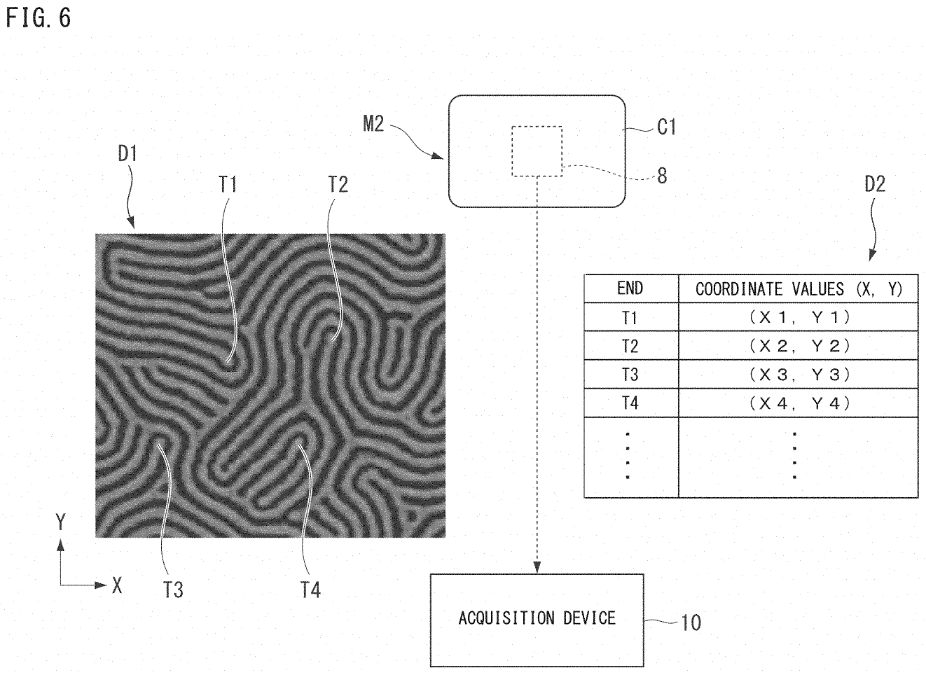

FIG. 6 is a diagram showing another example of the authentication medium. An authentication medium M2 may be, for example, a memory storage medium containing at least either one of image data related to the image mentioned above and feature data related to the features extracted from the image mentioned above. As shown in FIG. 6, a card or the like serving as the authentication object C1 may include a memory storage medium 8 serving as an authentication medium M2. The memory storage medium 8 is, for example, an IC tag, an RFID (radio frequency identifier) tag, or the like. At least either one of image data D1 and feature data D2 is stored in the memory storage medium 8.

The image data D1 is data that enables recognition of pattern features in the above image, and includes authentication information. An arbitrary data format such as JPEG (Joint Photographic Experts Group), GIF (Graphics Interchange Format), PNG (Portable Network Graphics), TIFF (Tagged Image File Format), BMP (Bitmap Image), or PDF (Portable Document Format) can be applied to the image data D1. The image data D1 may be RAW data acquired by the scanning electron microscope MS.

The feature data D2 shows an example of a case where end parts T1, T2, T3, T4, . . . of the white lines in the image data D1 are extracted as feature portions. The feature portions of the feature data D2 are not limited to the end parts T1, T2, T3, T4, . . . of the white lines, and may be other portions such as end parts of the black lines. The number of feature portions in a single image can be set arbitrarily. The feature data D2 may be, for example, coordinate values of the end parts T1, T2, T3, T4, . . . on the image. The feature data D2 is data in which the end part T1 indicates the coordinate values (X1, Y1), the end part T2 indicates the coordinate value (X2, Y2), the end part T3 indicates the coordinate values (X3, Y3), the end part T4 indicates the coordinate values (X4, Y4), and so on where the vertical direction of the image is the Y direction and the horizontal direction is the X direction, for example.

The image data D1 and the feature data D2 are acquired by, for example, an acquisition device 10 capable of receiving data stored in the memory storage medium 8 serving as the authentication medium M2. The acquisition device 10 includes, for example, a receiver capable of receiving the image data D1 or the feature data D2. The details of the acquisition device 10 will be described later.

### Authentication System

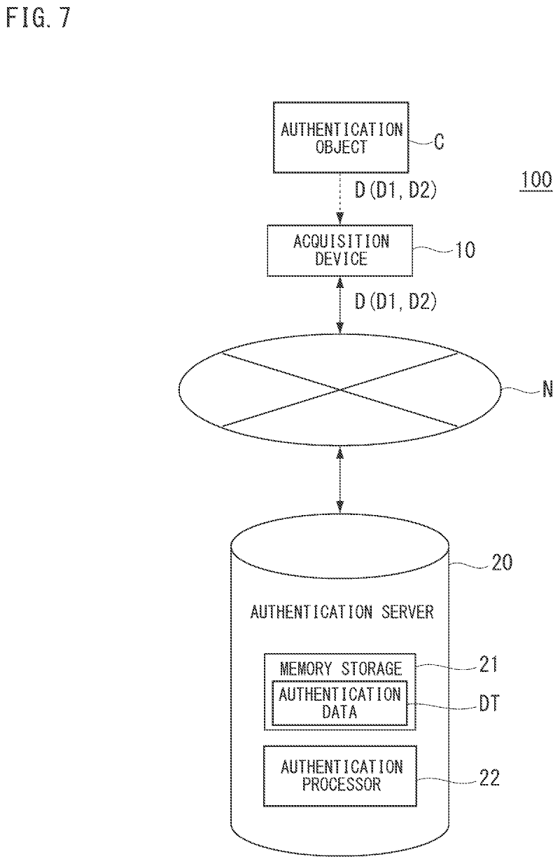

FIG. 7 is a diagram showing an example of an authentication system 100 according to the present embodiment. The authentication system 100 is a system for authenticating an authentication object. The authentication system 100 includes an acquisition device 10 and an authentication server 20.

The acquisition device 10 acquires authentication information D (D1, D2, and so forth) from the authentication medium M1 or the like provided in the authentication object C (C1, C2, C3, and so forth). As the acquisition device 10, a device capable of acquiring the authentication information D in a manner suitable for the authentication medium M1 is used. For example, in the case where the authentication medium M1 is an indicator P containing an image, a reading device or the like capable of reading the indicator P (image) is used as the acquisition device 10. The reading device is, for example, an image capturing device such as a scanner or a camera, and reads the image indicated on the indicator P, converts it into electronic data, and acquires it as authentication information D.

In the case where the memory storage medium 8 having at least either of the image data D1 and feature data D2 mentioned above stored therein serves as the authentication medium M2, the acquisition device 10 includes a receiver capable of receiving the image data D1 or the feature data D2. The acquisition device 10 includes, for example, an IC card reader, an RFID reader, or the like. The image data D1 and the feature data D2 are authentication information D acquired from the authentication medium M2 by the acquisition device 10.

The authentication server 20 authenticates the authentication information D acquired by the acquisition device 10, on the basis of preliminarily registered authentication data DT (the authentication data DT may be referred to as authentication-use data DT). The authentication information D includes, for example, the image data D1 or the feature data D2 acquired by the acquisition device 10. The authentication server 20 may be configured being connected to the acquisition device 10 via a communication line N, for example, however, the invention is not limited to this configuration. A memory storage medium such as a USB memory in which the authentication information D is stored may be connected to the authentication server 20.

The authentication server 20 has a memory storage 21 and an authentication processor 22. The memory storage 21 stores the authentication data DT. The authentication data DT stored in the memory storage 21 is registered preliminarily. The authentication data DT includes image data related to the image of a part of the phase separation structure formed on a substrate from a resin composition for phase separation structure formation. The authentication system 100 can use the original image data related to the image mentioned above as authentication data DT, and use the duplicate data of the authentication data DT as the image data D1 mentioned above, for example. The memory storage 21 may store image data of images of different parts of the phase separation structure as authentication data DT. The authentication data DT may be feature data (corresponding to the feature data D2 described above) related to features extracted from an image.

The authentication processor 22 determines whether or not the authentication data DT stored in the memory storage 21 matches the authentication information D acquired by the acquisition device 10, and performs authentication on the basis of the determination result. In the case where the authentication information D is image data D1, the authentication processor 22 compares, for example, the image indicated by the authentication information D with the image indicated by the authentication data DT. The authentication processor 22 may compare color information such as color tone and gradation at each point in the image indicated by the image data D1 with color information such as color tone and gradation at each point in the image indicated by the authentication data DT. In the case where the authentication information D is feature data D2, the authentication processor 22 compares, for example, the coordinate values of each point in the image data D1 with the coordinate values of the feature portion in the authentication data DT.

If the matching rate is greater than or equal to a first threshold value as a result of comparing the images, the authentication processor 22 can determine that the image data D1 and the authentication data DT match with each other. If the matching rate is less than or equal to the first threshold value as a result of comparing the images, the authentication processor 22 can determine that the image data D1 and the authentication data DT do not match with each other. If the matching rate is greater than or equal to a second threshold value as a result of comparing the coordinate values of each point, the authentication processor 22 can determine that the feature data D2 and the authentication data DT match with each other. If the matching rate is less than or equal to the second threshold value as a result of comparing the coordinate values of each point, the authentication processor 22 can determine that the feature data D2 and the authentication data DT do not match with each other. The first threshold value and the second threshold value mentioned above can be set to arbitrary values.

In the case where the authentication information D is the image data D1 or the feature data D2, it can be said that the possibility of physical changes to occur is low as compared with the case where the authentication information D is authentication information D acquired from the indicator P by the acquisition device 10. Therefore, in the case where the authentication information D is the image data D1 or the feature data D2, it is possible to set strict conditions for determining the authentication information D and the authentication data DT.

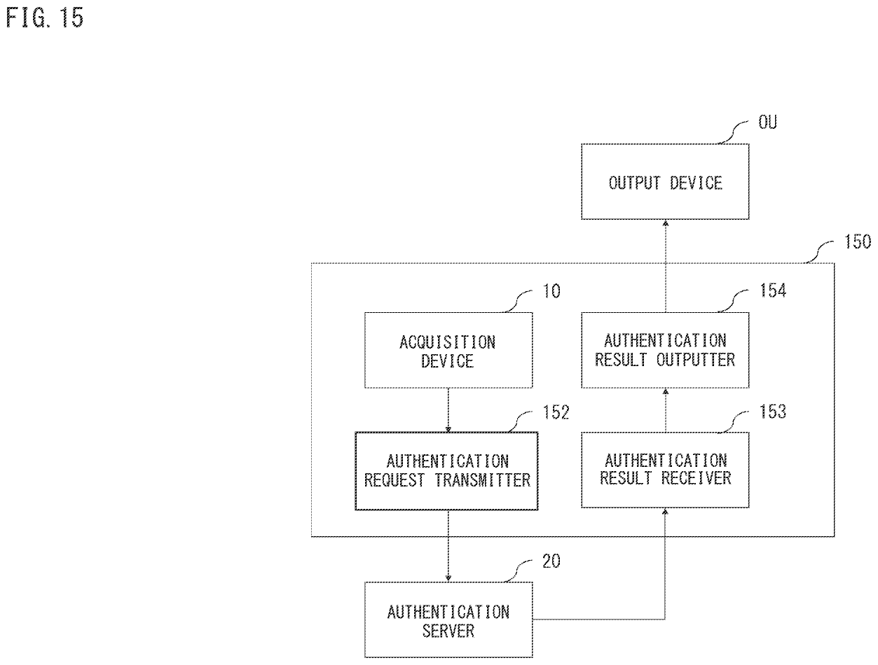

For example, in the case where the authentication processor 22 determines that the authentication data DT and the authentication information D match with each other, the authentication processor 22 may output to an output device such as display device the authentication result indicating that they match with each other. In the case where the authentication processor 22 determines that the authentication data DT and the authentication information D do not match with each other, the authentication processor 22 may output, for example, to an output device OU (see FIG. 15) the authentication result indicating that they do not match with each other. The output device OU is, for example, a display device. The authentication processor 22 may display the authentication result on the display device.

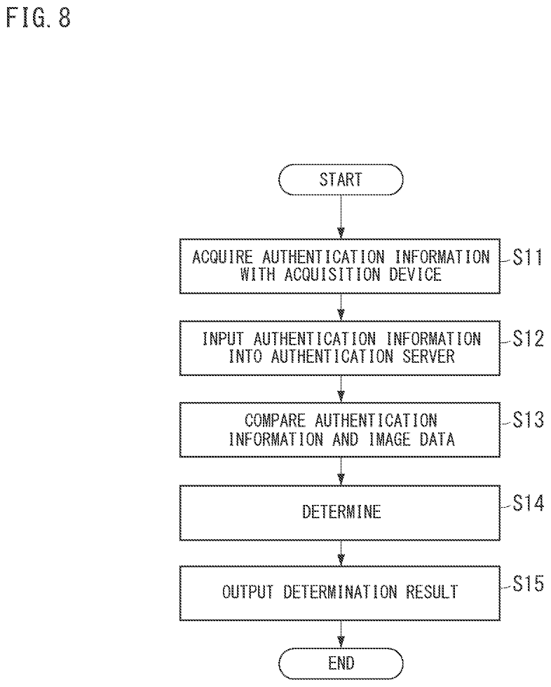

FIG. 8 is a flowchart showing an example of a process in the authentication system 100. As shown in FIG. 8, first, authentication information D is acquired by the acquisition device 10 (Step S11). After having acquired the authentication information D, the acquisition device 10 outputs the acquired authentication information D. The authentication information D output from the acquisition device 10 is input to the authentication server 20 via the communication line N (Step S12). In the authentication server 20, the authentication processor 22 compares the input authentication information D with the authentication data DT stored in the memory storage 21 (Step S13). The authentication processor 22 determines whether or not the authentication information D and the authentication data DT match with each other (Step S14). The authentication processor 22 outputs the determination result to an output device or the like not shown in the drawings (Step S15).

### Another Example of Authentication System

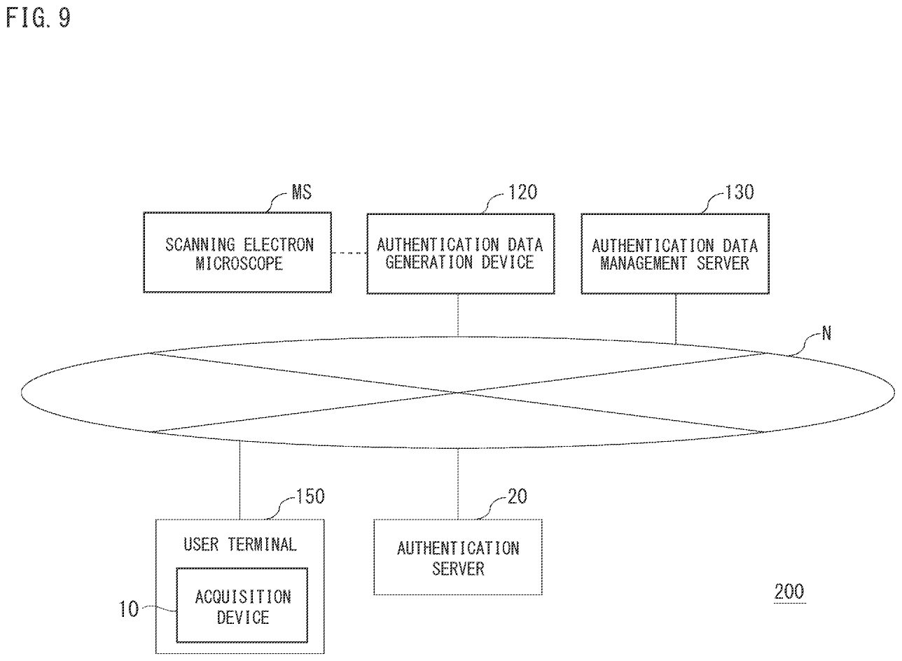

FIG. 9 is a diagram showing another example of the authentication system. An authentication system 200 shown in FIG. 9 is of a configuration in which a generation system for generating authentication data is added in addition to the authentication system 100 described above. The authentication system 200 described below is merely an example and is not limited to this example.

The authentication system 200 includes an authentication data generation device 120, an authentication data management server 130, an authentication server 20, and a user terminal 150. The authentication data generation device 120, the authentication data management server 130, the authentication server 20, and the user terminal 150 are connected to the communication line N. Here, the communication line N includes a computer network such as the Internet, a core network of a telecommunications carrier, and various types of local networks.

The scanning electron microscope MS and the authentication data generation device 120 may be communicably connected, and image data obtained by the scanning electron microscope MS may be sent to the authentication data generation device 120 via a predetermined communication line or the like. Alternatively, image data obtained by the scanning electron microscope MS may be stored in a memory storage medium such as a USB memory, and the authentication data generation device 120 may acquire the image data through the memory storage medium. For example, the scanning electron microscope MS obtains image data of the structure (phase separation structure) 3S, 4 on the substrate 1 and sends the image data to the authentication data generation device 120.

The authentication data generation device 120 is a server that generates authentication data DT used for confirming the validity and authenticity of an authentication object C1 and the like. Upon receiving the image data of the structure (phase separation structure) 3S, 4 from the scanning electron microscope MS, the authentication data generation device 120 generates authentication data DT from the image data. After having generated authentication data DT, the authentication data generation device 120 transmits the authentication data DT to the authentication data management server 130 via the communication line N.

The authentication data management server 130 is a server that manages authentication data DT. Upon receiving authentication data DT from the authentication data generation device 120, the authentication data management server 130 manages the authentication data DT. Upon receiving a provision request for authentication data DT from the authentication server 20, the authentication data management server 130 transmits authentication data DT to the authentication server 20.

As described above, the authentication server 20 is a server that authenticates a target authentication object C1 or the like. Upon registering information of the authentication object C1 or the like to be authenticated, the authentication server 20 transmits to the authentication data management server 130 a request for providing authentication data DT for authenticating the authentication object C1 or the like. Upon receiving authentication data DT from the authentication data management server 130, the authentication server 20 manages the authentication data DT while associating it with the authentication object C1 or the like to be authenticated. Upon receiving from the user terminal 150 an authentication request including authentication information D related to the authentication object C1 or the like, the authentication server 20 authenticates the authentication object C1 or the like and transmits authentication result data including the authentication result to the user terminal 150.

The user terminal 150 is a terminal that includes the acquisition device 10 mentioned above and is used in the field for confirming the validity and authenticity of the authentication object C1 or the like. Upon acquiring the authentication information D assigned to the authentication object C1 or the like by means of the acquisition device 10, the user terminal 150 transmits to the authentication server 20 data that includes the authentication information D and indicates a request for authentication of the authentication object C1 or the like. Upon receiving the authentication result data from the authentication server 20, the user terminal 150 outputs the authentication result to the display device or the like.

In order to avoid undue complication of description, in the present embodiment, there is described a configuration in which the authentication system 200 includes one each of the authentication data generation device 120, the authentication data management server 130, the authentication server 20, and the user terminal 150. However, the authentication system 200 may include several of each of the authentication data generation device 120, the authentication data management server 130, the authentication server 20, and the user terminal 150.

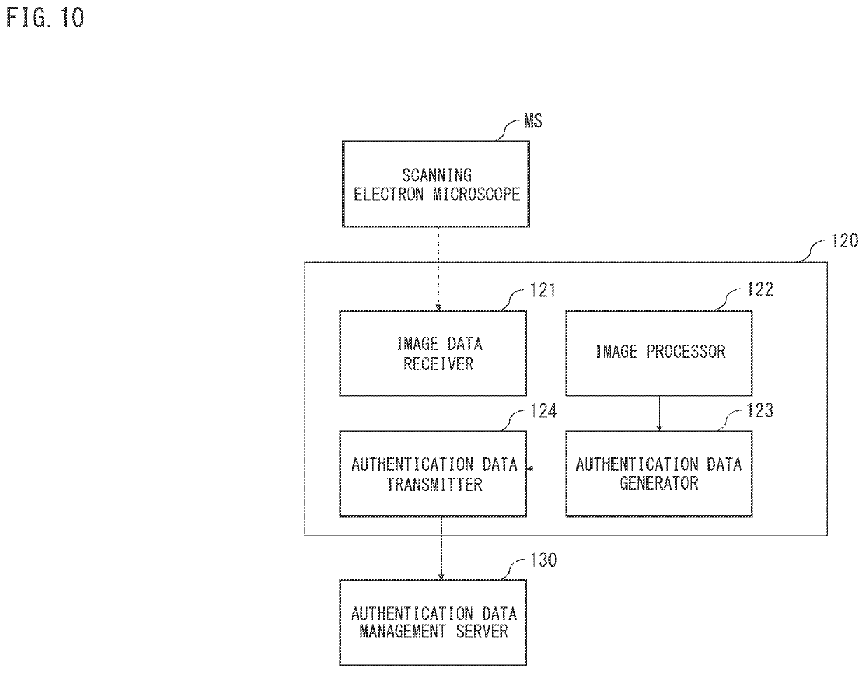

FIG. 10 is a block diagram showing an example of the configuration of the authentication data generation device 120. The authentication data generation device 120 includes, for example, an image data receiver 121, an image processor 122, an authentication data generator 123, and an authentication data transmitter 124.

The image data receiver 121 receives image data of the structure (phase separation structure) 3S, 4 from the scanning electron microscope MS. The image processor 122 divides the image of the image data received by the image data receiver 121 to generate a plurality of images. The authentication data generator 123 extracts a plurality of feature points of a pattern in each image generated by the image processor 122, and generates authentication data DT that enables identification of the plurality of feature points. The authentication data transmitter 124 associates the authentication data DT generated by the authentication data generator 123 with the image used to generate the authentication data DT and transmits it to the authentication data management server 130.

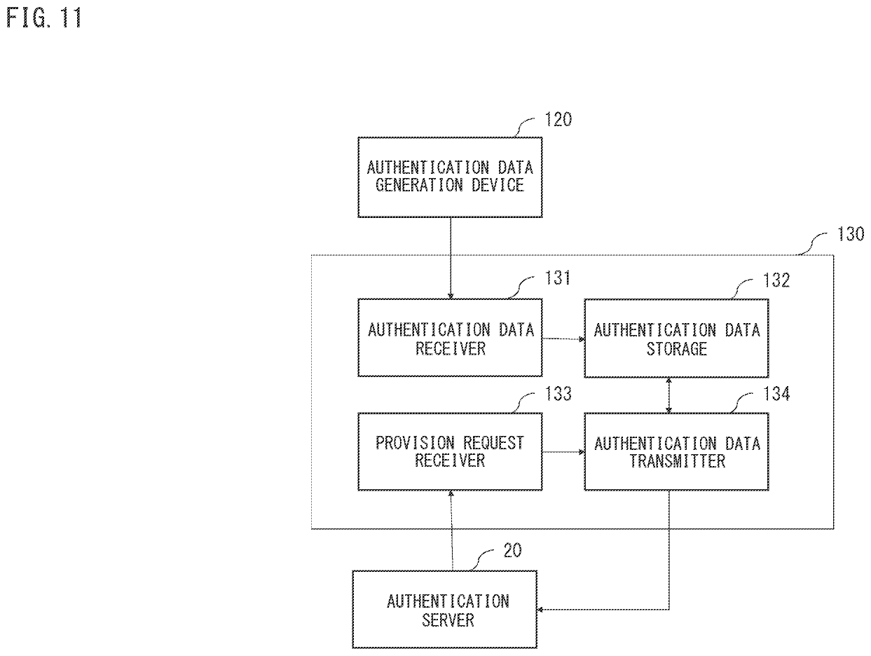

FIG. 11 is a block diagram showing an example of the configuration of the authentication data management server 130. The authentication data management server 130 includes an authentication data receiver 131, an authentication data storage 132, a provision request receiver 133, and an authentication data transmitter 134.

The authentication data receiver 131 receives the authentication data DT from the authentication data generation device 120. The authentication data storage 132 stores the authentication data DT received by the authentication data receiver 131 and information of the provision destination that provided the authentication data DT while associating them with each other. The provision request receiver 133 receives from the authentication server 20 a request for provision of the authentication data DT. The authentication data transmitter 134 transmits the authentication data DT stored in the authentication data storage 132 to the authentication server 20 in response to the provision request received by the provision request receiver 133.

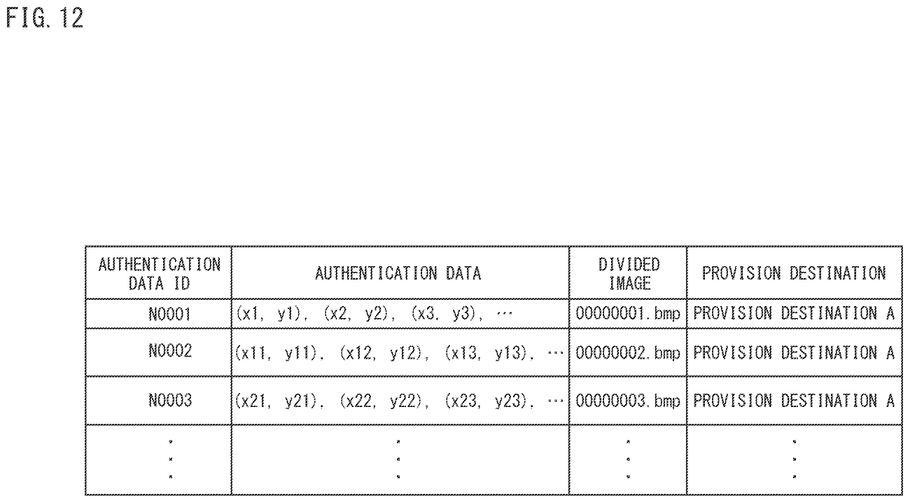

FIG. 12 is a diagram showing, in a form of a table, an example of the information stored in the authentication data storage 132. The authentication data storage 132 stores information including IDs of authentication data DT (referred to as authentication data ID in FIG. 12), authentication data DT, divided images (images), and provision destinations while associating them with each other. The information of an ID of authentication data DT is an identification code for uniquely identifying the authentication data DT. The information of authentication data DT is information that indicates the authentication data DT identified by the ID of the authentication data DT. For instance, this example illustrates that the authentication data DT identified by the ID “N0001” of the authentication data DT is “(x1, y1), (x2, y2), (x3, y3), . . . ”.

The information of a divided image is information that indicates the divided image used for generating the authentication data DT identified by the ID of the authentication data DT. For instance, this example illustrates that the divided image used for generating the authentication data DT identified by the ID “N0001” of the authentication data DT is “00000001.bmp”.

The information of a provision destination is information that indicates the provision destination of the authentication data DT identified by the ID of the authentication data DT. For instance, this example illustrates that the provision destination of the authentication data DT identified by the ID “N0001” of the authentication data DT is “provision destination A”.

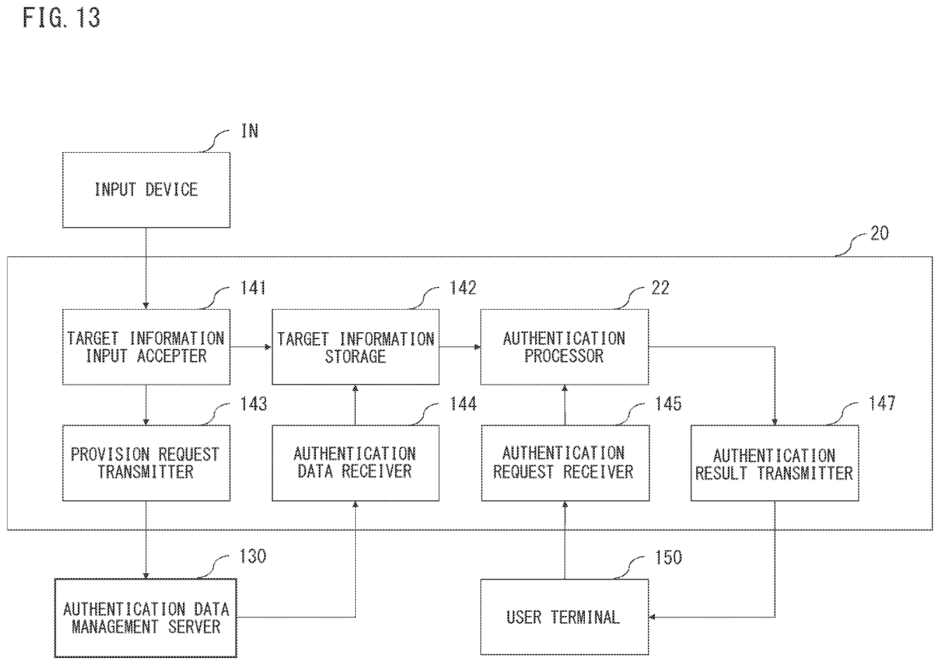

FIG. 13 is a block diagram showing an example of the configuration of the authentication server. The authentication server 20 includes a target information input accepter 141, a target information storage 142, a provision request transmitter 143, an authentication data receiver 144, an authentication request receiver 145, an authentication processor 22, and an authentication result transmitter 147.

The target information input accepter 141 accepts an input of information of an authentication object C1 or the like to be authenticated via an input device IN. Here, the input device IN is a device for providing data, information, instructions, and so forth to the authentication server 20, and is, for example, a touch panel, a keyboard, a mouse, or the like. The target information storage 142 stores the information of the authentication object C1 or the like, the input of which has been accepted by the target information input accepter 141, and authentication information D for authenticating the authentication object C1 or the like, while associating them with each other. The provision request transmitter 143 transmits to the authentication data management server 130 data that indicates a request for provision of authentication data DT required for authenticating the authentication object C1 or the like. The authentication data receiver 144 receives from the authentication data management server 130 the authentication data DT required for authenticating the authentication object C1 or the like. The authentication request receiver 145 receives from the user terminal 150 data that includes the authentication information D assigned to the authentication object C1 or the like to be authenticated and that indicates a request for an authentication to be performed. The authentication processor 22 performs the process of authentication, using the authentication data DT and so forth received by the authentication request receiver 145. The authentication result transmitter 147 transmits to the user terminal 150 data that includes the authentication result of the authentication process performed by the authentication processor 22.

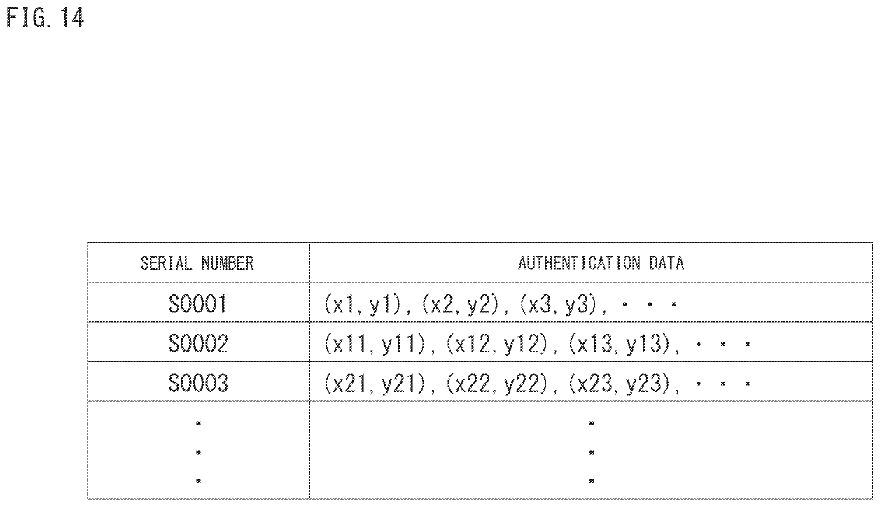

FIG. 14 is a diagram showing, in a form of a table, an example of information stored in the target information storage 142. The target information storage 142 stores information of serial numbers and authentication data DT while associating them with each other. The information of a serial number is an identification code for uniquely identifying an authentication object C1 or the like.

The information of authentication data DT is information that indicates the authentication data DT for authenticating an authentication object C1 or the like identified by a serial number. For instance, this example illustrates that the authentication data DT for authenticating a target identified by the ID “S0001” is “(x1, y1), (x2, y2), (x3, y3), . . . ”.

FIG. 15 is a block diagram showing an example of the configuration of the user terminal 150. The user terminal 150 includes an acquisition device 10, an authentication request transmitter 152, an authentication result receiver 153, and an authentication result outputter 154.

The acquisition device 10 acquires authentication information D (including image data D1 or feature data D2) assigned to an authentication object C1 or the like to be authenticated. The authentication request transmitter 152 transmits to the authentication server 20 data that includes the authentication information D acquired by the acquisition device 10 and that indicates a request for an authentication to be performed. The authentication result receiver 153 receives data including the authentication result from the authentication server 20. The authentication result outputter 154 outputs to the output device OU the authentication result included in the data received by the authentication result receiver 153. Here, the output device OU is a device that receives data from the user terminal 150 and physically presents it to the outside in a form that can be recognized by the user, and is a display device, for example.

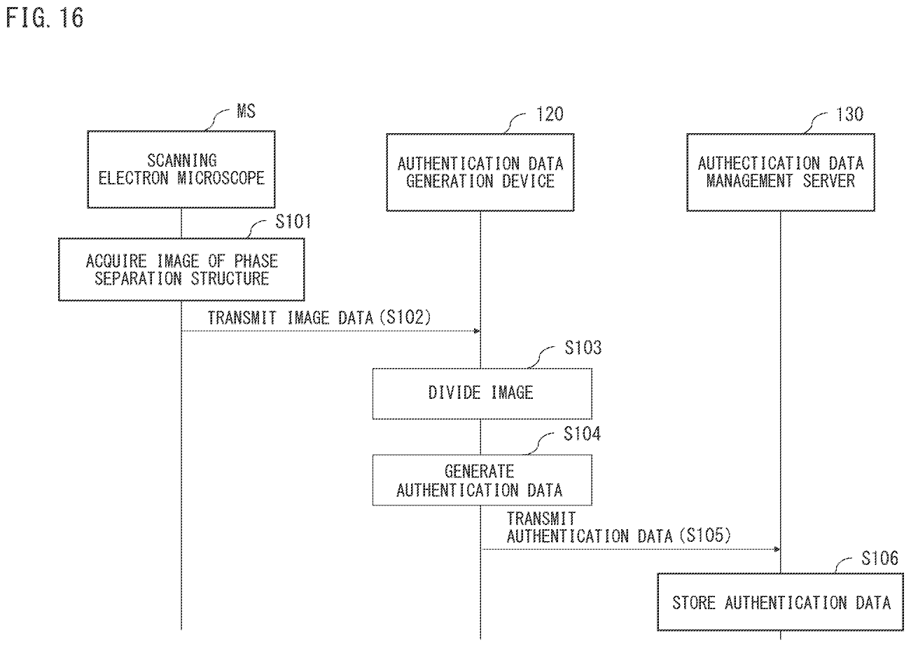

FIG. 16 is a diagram showing an example of an operation sequence of the scanning electron microscope MS, the authentication data generation device 120, and the authentication data management server 130. In this operation sequence, there is described a process from the moment of image acquisition performed by the scanning electron microscope MS to the moment where a plurality of authentication data DT become available for provision. In the description of this operation sequence, reference will be made to FIG. 10 to FIG. 15 where appropriate.

The business operator providing authentication data DT has preliminarily acquired images of the structure (phase separation structure) 3S, 4, using the scanning electron microscope MS in order to generate authentication data DT according to a predetermined schedule or when a transaction for providing authentication data DT is concluded (Step S101). The image data is sent to the authentication data generation device 120 (Step S102). Upon receiving the image data, the image data receiver 121 of the authentication data generation device 120 sends the image data to the image processor 122.

Upon receiving the image data from the image data receiver 121, the image processor 122 of the authentication data generation device 120 divides the image of the image data to generate a plurality of images (Step S103). In the process of Step S103, the image processor 122 generates a plurality of images from a single image of the structure (phase separation structure) 3S, 4, for example. In Step S101, the scanning electron microscope MS need not perform Step S103 in the case of acquiring an image for each region corresponding to a part of the structure (phase separation structure) 3S, 4. Having generated a plurality of images, the image processor 122 sends the plurality of images to the authentication data generator 123.

Upon receiving the plurality of images from the image processor 122, the authentication data generator 123 of the authentication data generation device 120 extracts a plurality of feature points of a pattern captured in each of the plurality of images, and generates authentication data DT that enables identification of the plurality of feature points (Step S104). In the process of Step S104, for example, the authentication data generator 123 extracts the end parts T1 to T4 of the white lines from the pattern captured in the image of the indicator P as feature points as shown in FIG. 6, and generates coordinate values indicating the positions of the feature points as authentication data DT. Having generated a plurality of authentication data DT, the authentication data generator 123 sends the plurality of authentication data DT to the authentication data transmitter 124. Upon receiving the plurality of authentication data DT from the authentication data generator 123, the authentication data transmitter 124 associates the plurality of authentication data DT with the image used to generate the authentication data DT and transmits them to the authentication data management server 130 (Step S105).

Upon receiving the plurality of authentication data DT and the image used to generate the authentication data DT from the authentication data generation device 120, the authentication data receiver 131 of the authentication data management server 130 associates the corresponding authentication data DT and the image and store them in the authentication data storage 132 (Step S106). In the process of Step S106, for example, as shown in FIG. 12, each information of the authentication data DT and the image is assigned with the ID of authentication data DT and is stored. In this way, it becomes possible to provide the plurality of authentication data DT required for authenticating an authentication object C1 or the like.

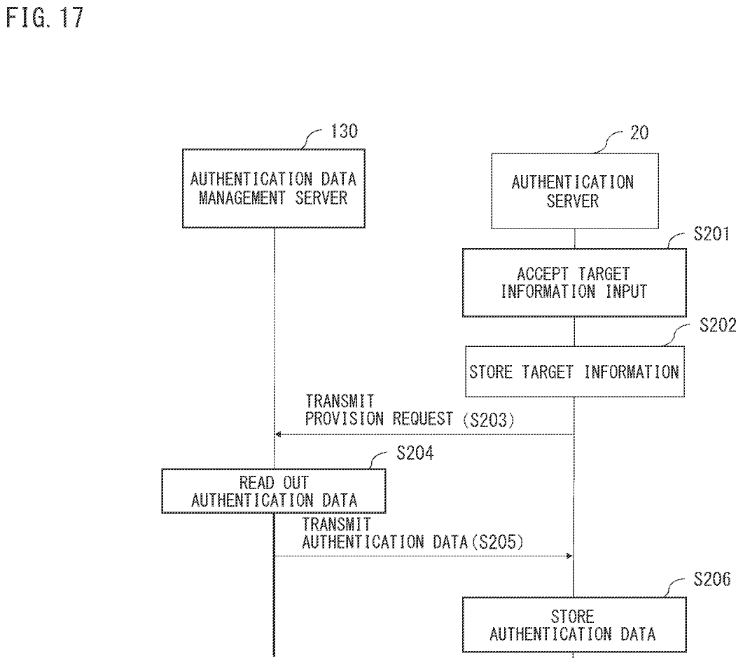

FIG. 17 is a diagram showing an example of an operation sequence of the authentication data management server 130 and the authentication server 20. In this operation sequence, there is described a process from the moment of accepting an input of information of an authentication object C1 or the like to be authenticated, to the moment where it becomes possible to authenticate the authentication object C1 or the like. In the description of this operation sequence, reference will be made to FIG. 10 to FIG. 16.

The business operator that authenticates an authentication object C1 or the like inputs, in response to a new authentication object C1 or the like to be authenticated having been prepared, the information of the authentication object C1 or the like into the authentication server 20.

Upon accepting the input of information (referred to as target information in FIG. 17) of the authentication object C1 or the like to be authenticated (Step S201), the target information input accepter 141 of the authentication server 20 stores the information in the target information storage 142 (Step S202) and sends the data indicating the number of information on the authentication object C1 or the like, the input of which has been accepted, to the provision request transmitter 143. In the process of Step S201, the target information input accepter 141 accepts an input of the serial number of the authentication object C1 or the like as information of the authentication object C1 or the like to be authenticated, for example. In the process of Step S202, for example, as shown in FIG. 14, the information of the serial number is stored.

Upon receiving the data from the target information input accepter 141, the provision request transmitter 143 of the authentication server 20 transmits to the authentication data management server 130 data that indicates a request for provision of authentication data DT required for authenticating the authentication object C1 or the like (Step S203). In the process of Step S203, the provision request transmitter 143 transmits to the authentication data management server 130 data that indicates a request for the same number of authentication data DT as the number of information of the authentication object C1 or the like indicated by the data received from the target information input accepter 141, for example.

Upon receiving the provision request for authentication data DT from the authentication server 20, the provision request receiver 133 of the authentication data management server 130 sends to the authentication data transmitter 134 data that includes the requested number of authentication data DT and information that enables identification of the request origin. Upon receiving the data from the provision request receiver 133, the authentication data transmitter 134 reads out the requested number of authentication data DT from the authentication data storage 132 (Step S204), and transmits the read authentication data DT to the authentication server 20 (Step S205). In the process of Step S204, for example, upon reading out authentication data, the authentication data transmitter 134 associates, as information of the provision destination, the information that enables identification of the request origin included in the data received from the provision request receiver 133 with the information of the read authentication data DT, and stores them in the authentication data storage 132, as shown in FIG. 12.

Upon receiving the authentication data DT from the authentication data management server 130, the authentication data receiver 144 of the authentication server 20 associates the authentication data DT with the information of the authentication object C1 or the like to be authenticated stored in the target information storage 142 (Step S206). In the process of Step S206, for example, as shown in FIG. 14, the information of a serial number is associated with authentication data DT to be stored. Thereby, it becomes possible to authenticate the target.

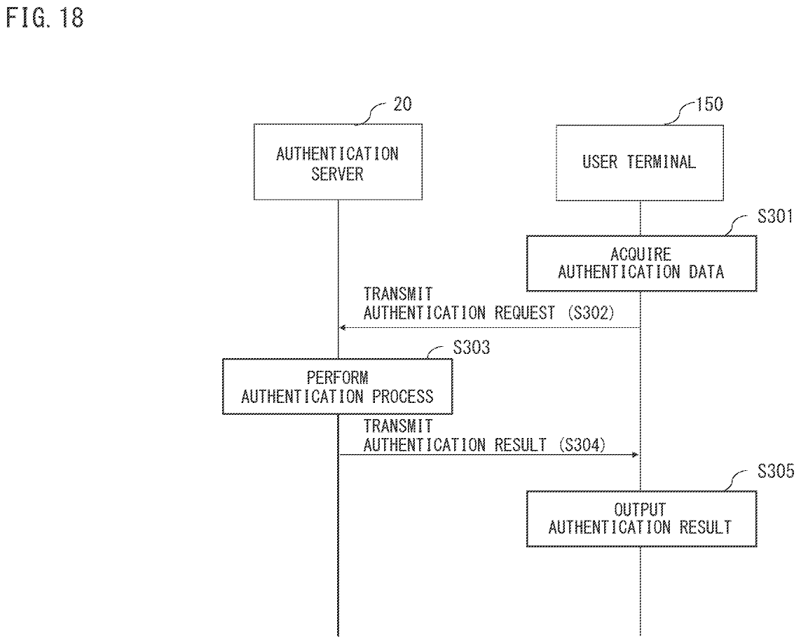

FIG. 18 is a diagram showing an example of an operation sequence of the authentication server 20 and the user terminal 150. In this operation sequence, there is described a process from the moment of acquiring authentication information D assigned to an authentication object C1 or the like to be authenticated to the moment of outputting the authentication result. In the description of this operation sequence, reference will be made to FIG. 10 to FIG. 17.

The user that desires to authenticate an authentication object C1 or the like performs an operation of acquiring authentication information D assigned to the authentication object C1 or the like. As an example, an IC tag serving as an authentication medium M2 is attached to the authentication target (for example, the authentication object C2). The IC tag is a micro wireless IC chip used for identifying the authentication object C2. The IC tag stores authentication information D for authenticating the authentication object C2 having the IC tag attached thereto and the serial number of the authentication object C2. In the case of such a configuration, the user terminal 150 reads and acquires the authentication information D and the serial number stored in the IC tag by means of an IC card reader serving as the acquisition device 10.

As another example, the IC tag attached to the authentication object C2 to be authenticated stores information of an image (image data D1) having been used to generate authentication data DT and the serial number of the authentication object C2. In the case of such a configuration, the user terminal 150 reads and acquires the image and the serial number stored in the IC tag by means of the acquisition device 10.

As another example, on an authentication target (for example, an authentication object C1) there is provided a indicator P on which the image having been used to generate authentication data DT is printed. The indicator P may include the serial number of the authentication object C1. In the case of such a configuration, the user terminal 150 image-captures the indicator P (including the serial number and so forth) with, for example, a digital camera, and reads and acquires the image of the indicator P.

As another example, in the case where the authentication target is data, in the data there are embedded authentication information for authenticating the data and the serial number of the data by means of an electronic watermarking technique or the like. Here, electronic watermarking is a technique for embedding related information in data such as an image, moving image, and sound in a form that cannot be perceived by a human. In the case of such a configuration, the user terminal 150 acquires authentication information D and a serial number embedded in data by means of dedicated software capable of detecting them.

Upon acquiring the authentication information D assigned to the authentication object C1 or the like (Step S301), the acquisition device 10 of the user terminal 150 sends the authentication information D and so forth to the authentication request transmitter 152. Upon receiving the authentication information D from the acquisition device 10, the authentication request transmitter 152 transmits to the authentication server 20 data that includes the authentication information D and that indicates a request for an authentication to be performed (Step S302).

Upon receiving from the user terminal 150 the data that includes the authentication information D and that indicates a request for an authentication, the authentication request receiver 145 of the authentication server 20 sends the authentication information D to the authentication processor 22. Upon receiving the authentication information D and so forth from the authentication request receiver 145, the authentication processor 22 performs the process of an authentication, using the authentication information D (Step S303).

In the process of Step S303, for example, when the authentication information D and the serial number have been received from the authentication request receiver 145, the authentication processor 22 determines whether or not a serial number that matches the serial number received from the authentication request receiver 145 is stored among the information stored in the target information storage 142. If a matching serial number is stored, the authentication processor 22 reads out the authentication data DT that is stored and is associated with the serial number. Then, the authentication processor 22 determines whether or not the authentication data DT read out from the target information storage 142 and the authentication information D received from the authentication request receiver 145 match. If the two match, the authentication processor 22 sends to the authentication result transmitter 147 authentication result data that indicates the authentication result being “true”. If the two do not match, the authentication processor 22 sends to the authentication result transmitter 147 authentication result data that indicates the authentication result being “false”.

In the process of Step S303, for example, in the case where information of an image and a serial number is received from the authentication request receiver 145, the authentication processor 22, by means of the same method as that used by the authentication data generation device 120 to generate authentication data DT, extracts from the image a plurality of feature points of a pattern captured in the image, and generates authentication information DX that enables identification of the plurality of feature points. Further, the authentication processor 22 determines whether or not a serial number that matches the serial number received from the authentication request receiver 145 is stored among the information stored in the target information storage 142. If a matching serial number is stored, the authentication processor 22 reads out the authentication data DT that is stored and is associated with the serial number. Then, the authentication processor 22 determines whether or not the authentication data DT read out from the target information storage 142 and the authentication information DX mentioned above match with each other. If the two match, the authentication processor 22 sends to the authentication result transmitter 147 authentication result data that indicates the authentication result being “true”. If the two do not match, the authentication processor 22 sends to the authentication result transmitter 147 authentication result data that indicates the authentication result being “false”.

Upon receiving the authentication result data from the authentication processor 22, the authentication result transmitter 147 of the authentication server 20 transmits the authentication result to the user terminal 150 (Step S304).

Upon receiving the authentication result data from the authentication server 20, the authentication result receiver 153 of the user terminal 150 transmits the authentication result to the authentication result outputter 154. Upon receiving the authentication result data from the authentication result receiver 153, the authentication result outputter 154 outputs the authentication result indicated by the authentication result data via the output device OU (Step S305). Thereby, the user that desires to authenticate the target can confirm the validity and authenticity of the target (authentication object C1 or the like).

As described above, according to the authentication object C1 and the authentication systems 100, 200 of the present embodiment, since the authentication media M1, M2 having authentication information D including features related to a part of the structure (phase separation structure) 3S, 4 formed on the substrate 1 are used, and no identical patterns exist in the structure (phase separation structure) 3S, 4 as with human fingerprints, it is possible to perform highly secure authentication as in fingerprint authentication. Further, since a multitude of different images (patterns) can be obtained from a single structure (phase separation structure) 3S, 4 for generating the authentication media M1, M2, a multitude of the authentication media M1, M2 can be easily and inexpensively created.

While the present invention has been described, the technical scope of the invention is not limited to the scope set forth in the embodiment. It will be apparent to those skilled in the art that various modifications or improvements may be made to the embodiment. It is also apparent from descriptions in claims that embodiments with such modifications or improvements can be encompassed within the technical scope of the present invention.

It should be noted that the order of executing processes, such as actions, procedures, steps, and phases in the systems, devices, programs, and memory storage media set forth in the claims, specification, and drawings may be performed in any order unless specifically stated as “before”, “prior to”, or the like, and unless output from the preceding process is used in the subsequent process. “First”, “then” or the like, even if used in relation to a process flow or operation sequence in the claims, specification, and drawings for convenience, do not mean that execution in the described order is essential.

Furthermore, in addition to the configurations described above, a configuration for authenticating with an ID/password may be added to the authentication systems 100, 200. In such a case, reliable authentication can be realized by performing multi-factor authentication that combines biometric information, an IC card, or the like with authentication using an image of a phase separation structure according to the present embodiment.

The contents of Japanese Patent Application No. 2019-018420 and all documents cited in the detailed description of the present invention are incorporated herein by reference to the extent permitted by law.

### DESCRIPTION OF REFERENCE SIGNS

C1, C2, C3: Authentication object
D: Authentication information
D1: Image data
D2: Feature data
DT: Authentication data
M1, M2: Authentication medium
MS: Scanning electron microscope
N: Communication line
P: Indicator
1: Substrate
2: Base layer
3: BCP layer
3a, 3b: Phase
3S, 4: Structure
6: Tag
10: Acquisition device
20: Authentication server
100, 200: Authentication system

1. An authentication object that serves as a target of authentication performed by an authentication system, the authentication object comprising an authentication medium having authentication information that includes a feature related to a pattern of a part of a phase separation structure formed on a substrate from a resin composition for phase separation structure formation and is to be acquired by an acquisition device provided in the authentication system.

2. The authentication object according to claim 1, wherein the authentication medium is an indication body that indicates an image of a part of the phase separation structure obtained by means of a scanning electron microscope.

3. The authentication object according to claim 1, wherein the authentication medium is a memory storage medium that stores image data of an image of a part of the phase separation structure obtained by means of a scanning electron microscope.

4. The authentication object according to claim 1, wherein the authentication medium is a memory storage medium that stores feature data related to a feature extracted from an image of a part of the phase separation structure obtained by means of a scanning electron microscope.

5. The authentication object according to claim 2, wherein the image is an image cropped from the phase separation structure on the substrate in a range from 0.5 μm×0.5 μm to 10 μm×10 μm.

6. The authentication object according to claim 2, wherein the image is one of a plurality of images obtained from a single substrate.

7. An authentication system that authenticates the authentication object according to claim 1, comprising:
an acquisition device that acquires the authentication information from the authentication medium included in the authentication object; and
an authentication server that authenticates the authentication information acquired by the acquisition device, on the basis of preliminarily registered authentication data.

8. The authentication system according to claim 7, wherein
the authentication medium is an indication body that indicates an image of a part of the phase separation structure obtained by means of a scanning electron microscope, and
the acquisition device acquires the authentication information by reading the image indicated on the indication body.

9. The authentication system according to claim 7, wherein
the authentication medium is a memory storage medium that stores image data related to an image of a part of the phase separation structure obtained by means of a scanning electron microscope, or feature data related to a feature extracted from an image of a part of the phase separation structure obtained by means of a scanning electron microscope, and
the acquisition device acquires the authentication information by receiving the image data or the feature data from the memory storage medium.

10. A method for producing an authentication medium having authentication information, to be authenticated by an authentication system, the method comprising:
forming a phase separation structure on a substrate from a resin composition for phase separation structure formation;
acquiring an image of a pattern of a part of the phase separation structure; and
generating the authentication information, using the image.
